(19) United States
(12) Patent Application Publication
(10) Pub. No.: US 2018/0169852 A1
(43) Pub. Date: Jun. 21, 2018

(54) Customizable And Ergonomic Handle

(71) Applicant: NEXTGEN KNIVES, LLC, Cambridge, MA (US)

(72) Inventors: Jeremy FRYER-BIGGS, New York, NY (US); Mikkel RESKE-NIELSEN, Cambridge, MA (US)

(73) Assignee: NEXTGEN KNIVES, LLC, Cambridge, MA (US)

(21) Appl. No.: 15/568,752

(22) PCT Filed: Mar. 23, 2016
(86) PCT No.: PCT/US2016/023818

§ 371 Date: Oct. 23, 2017

Related U.S. Application Data
(60) Provisional application No. 62/137,204, filed on Mar. 23, 2015.

(51) Int. Cl. B25G 1/10

(52) U.S. Cl. CPC B25G 1/102; B26B 3/00

(57) ABSTRACT

The invention provides a truly customizable and ergonomic handle suitable for a hand-held implement such as a chef's knife. Various features are provided in the handle to allow one to hold the knife in a pinch grip and other desired grips comfortably. The handle can be customized using data obtained from scanned images of the user's hand.

### CROSS-REFERENCE TO RELATED APPLICATIONS

This application claims priority to and the benefit of co-pending U.S. provisional patent application Ser. No. 62/137,204, filed Mar. 23, 2015, which application is incorporated herein by reference in its entirety.

### FIELD OF THE INVENTION

The invention relates to hand-held implements and accessories, more specifically to knives with ergonomic grips or handles, as well as methods of making them.

### BACKGROUND OF THE INVENTION

Use of hand-held tools or implements most often requires a comfortable yet firm grip. However, handles for those implements such as mechanic tools, gardening tools, surgical tools, sporting equipment (golf clubs, tennis racquets, etc.), guns, mobility controls (handle bars for motorcycle and bicycle, etc.) and knives, remain largely static in design and lacking in ergonomics. In particular, while knives and handle designs are disclosed in U.S. Pat. Nos. 6,564,685, 6,418,820, 6,263,581, 5,365,666, 4,955,139, 4,578,864, there is still much room for improvements.

In particular, a number of problems are yet to be adequately addressed by the design and construction of the handle. For users who hold an implement for extended periods of time or with high frequency, muscle fatigue can lead to premature loss of precision, strength or control. This obviously compromises the quality of work or user experience, and can easily lead to injuries. Another problem is how to provide, through the implement and its associated parts, better control of the implement.

For example, a popular technique to use a chef's knife among culinary professionals is called a “pinch grip,” where both the thumb and forefinger are extended distally to grasp opposing sides of the blade as if to “pinch” the blade, while the three remaining fingers wrap around the under belly of the handle (FIG. 1B). This enables one to pierce, slice, mince, julienne, fillet, and chop with much more precision and better control over the blade. However, because the blade is made of a thin piece of smooth metal, in a kitchen environment where there is plenty of grease and liquid, it is very difficult to try and hold the pinch grip for an extended period of time.

### SUMMARY OF THE INVENTION

To solve the above and other problems, the present invention provides a handle or grip for hand-held implements or instruments such as knives. In one aspect, the present invention, based on data analysis of large numbers of people's hands, provides default embodiments with built-in structural features that guide one or more digits of the hand into preselected positions to effect a preselected grip that is more ergonomic for the intended use of the implement. In another aspect, high levels of customization are introduced into the design and manufacturing process to reach the highest level of ergonomics—an individualized, personal close fit with the handle.

The foregoing and other objects, aspects, features, and advantages of the invention will become more apparent from the following description and from the claims.

In one aspect, the present invention provides a handle dimensioned to be held by a single human hand, said handle comprising a distal portion and a proximal portion, said portions together forming an upper back and an opposing lower belly as well as two lateral sides. The distal handle portion further comprises a thumb support and a forefinger support flanking a longitudinal axis of said handle, and wherein said thumb support and said forefinger support are staggered to facilitate a pinch grip by the human hand where both a thumb and a forefinger of the hand fictionally engage said thumb support and said forefinger support from respective lateral sides in order to grip said distal handle portion. And, a line between the closest points between said thumb support and said forefinger support defining an angle is between 30 and 90 degrees, exclusive of both endpoints, to said longitudinal handle axis. In some embodiments, that angle is between 40 and 89 degrees, inclusive of both endpoints. The closest distance between said thumb support and said forefinger support, in some embodiments, is between about 8.0 to about 15.0 mm.

In one feature, each of said thumb support and forefinger support comprises two walls defining a recess. Optionally the handle defines a cavity configured to fit a tang of a hand-held implement, said cavity defining said longitudinal handle axis.

In various features, the handle of the present invention can further include a thumb stop, a forefinger support, a pinkie stop and one ore more pressure spreading areas. In one embodiment, the handle distal portion further comprises a substantial, raised portion relative to the handle proximal portion for at least 2 mm, said raised portion configured for spreading pressure on the proximal phalanx of the forefinger and on the metacarpal. The upper back in the handle proximal portion may also be widened, e.g., for no less than 25 mm, for spreading pressure on the heel of the hand and has a width larger than any part of said distal portion.

In another aspect, the present invention provides handle dimensioned to be held by a single human hand, said handle comprising a distal portion and a proximal portion, said portions together forming an upper back and an opposing lower belly as well as two lateral sides, where said handle further comprises five recesses: a thumb recess, a forefinger recess, a middle finger recess, a ring finger recess and a small finger recess, each disposed and configured to respectively accommodate each of the five digits of the user's hand. In a feature, each of the five recesses comprises two walls defining a trough-like space. In an embodiment, one of the ridges defining said thumb recess comprises a reinforced thumb stop that extends perpendicularly away from said longitudinal handle axis for about 10 to about 25 mm.

According to another aspect of the invention, a knife is provided with a blade connected to a handle, said blade comprising a proximal side, at least part of which is covered by said handle, said handle comprising a distal portion and a proximal portion, said handle portions together forming an upper back and an opposing lower belly as well as two lateral sides, wherein said handle further comprises a pinch grip pad covering at least about one eighth (⅛) of the blade surface. In an embodiment, said pinch grip pad comprises a recess defined by two walls disposed to accommodate a user's thumb. The blade may be selected from the group consisting of a chef knife blade, a paring knife blade, a bread knife blade, a utility knife blade, a cleaver blade, and a steak knife blade.

In yet another aspect of the invention, a knife is disclosed to have a blade connected to a handle, said blade comprising body having a proximal side, at least part of which is covered by said handle, said handle comprising a proximal portion and a distal portion covering part of said blade body, said handle proximal portion and said handle distal portion joining to form a “J” having a back and an opposing belly as well as two lateral sides. In particular, said handle belly comprises a depression dimensioned and disposed over said blade proximal side to accommodate a user finger. Preferably, said depression is defined by a handle belly surface that is between about 10 to about 40 mm in width. In one feature, said blade proximal side comprises a cutout dimensioned and disposed to correspond to said depression in the handle belly. In various embodiment, the blade comprises a cleaver blade having four sides, or a blade having a pointed distal end.

The present invention further provides a handle dimensioned to be held by a single human hand, said handle comprising a distal portion and a proximal portion, said portions together forming an upper back and an opposing lower belly as well as two lateral sides, wherein said distal handle portion further comprises a thumb support and a forefinger support flanking a longitudinal axis of said handle, and wherein between said thumb support and said forefinger support, one comprises a raised rest and the other a recess; and wherein the average width of said handle distal portion is no less than 5 mm.

In another aspect, the present invention provides a method of making a customized ergonomic handle, comprising the steps of:

(a) providing a digital hand model mated to a handle; (b) extract biometric measurements about a hand through a digitized image of said hand; (c) inputting said biometric measurements as values in said digital model; (d) exporting resulting data into a machine readable code; and (e) directing a machine to automatically make a customized handle for an ergonomic fit with said hand using said machine readable code.

In yet another aspect, the present invention provides a container, such as a bag or a rollup bag, for storing and transporting sharp handheld implements, said container comprising at least one compartment for housing a handle portion of a handheld implement and a stab-resistant panel disposed proximate to said at least one compartment such that said panel can wrap around or otherwise surround any sharp portion of the implement. In a preferred embodiment, the stab-proof panel comprises an aramid fiber, and the container is overall flexible enough to be rolled up.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1A illustrates a popular embodiment of chef's knife in the prior art.

FIG. 1B illustrates and the pinch grip preferred by many chefs.

FIG. 2 illustrates an upper-perspective view of an exemplary embodiment of a knife according to the invention, taken from the right-rear side.

FIG. 3 illustrates an upper-perspective view of the same exemplary knife embodiment according to the invention, taken from the left-front side.

FIG. 4 illustrates a cross-sectional view of the same exemplary knife embodiment according to the invention, taken along a longitudinal axis from the left side.

FIG. 5 illustrates a side view of the same exemplary knife embodiment according to the invention, taken from the left side.

FIG. 6 illustrates a side view of the same exemplary knife embodiment according to the invention, taken from the right side.

FIG. 7 illustrates a top view of the same exemplary knife embodiment according to the invention.

FIG. 8 illustrates a bottom view of the same exemplary knife embodiment according to the invention.

FIGS. 9A-9E further illustrates a comfortable pinch grip by a right hand over a chef knife embodiment of the present invention.

FIG. 10A illustrates an upper-perspective view of an exemplary embodiment of a knife according to the invention, taken from the right-rear side.

FIG. 10B illustrates a lower-perspective view of the exemplary knife embodiment shown in FIG. 10A, taken from the lower left side.

FIG. 11 illustrates an upper-perspective view, side by side, of the handle portions of the embodiments illustrated respectively in FIGS. 2 and 10A.

FIG. 12A illustrates a comfortable pinch grip by a right hand over the paring knife embodiment illustrated in FIGS. 10A and 10B.

FIG. 12B illustrates a comfortable alternative grip by a right hand over the paring knife embodiment illustrated in FIGS. 10A and 10B.

FIG. 13A illustrates an upper-perspective view of an exemplary embodiment of a knife, specifically, a cleaver, according to the invention, taken from the left-rear side.

FIG. 13B illustrates a lower-perspective view of the same knife embodiment shown in FIG. 13A, taken from the right-rear side.

FIG. 13C illustrates an exploded view of the same knife embodiment shown in FIG. 13A before assembly.

FIG. 14 illustrates a comfortable pinch grip by a right hand over the knife embodiment illustrated in FIGS. 13A-13C.

FIG. 15 schematically illustrates features of how an embodiment can be made according to principles of the invention.

FIG. 16 illustrates an exploded view of a customized embodiment before the blade and handle parts are assembled into a knife.

FIG. 17A illustrates a right side view of the customized handle of FIG. 16.

FIG. 17B illustrates a left side view of the customized handle of FIG. 16.

FIG. 18 illustrate a rolled-up knife roll embodiment according to an aspect of the invention.

FIG. 19 illustrates the same knife roll embodiment when unrolled and opened showing its contents.

### DETAILED DESCRIPTION OF THE INVENTION

### I. Definition

Unless otherwise noted, technical terms are used according to conventional usage.

The term “ergonomic” as used herein refers to qualities in a product design that enhances user comfort and work efficiency, while lessening stress, muscle fatigue and risk of injury.

The term “recess” or “indentation” as used herein refers to a space that is indented or set back from the rest at least on one side, and preferably on both sides forming a concave surface. The recess or indentation described here, unless stated otherwise, is dimensioned to fit or accommodate at least part of a human (preferably adult) hand, e.g., part of a finger.

The term “tang” as used herein refers to a projecting shank, or prong that connects the rest of the implement (e.g., the blade in a knife) with the handle.

The present invention applies principles of ergonomics to the design of handles and grips for hand-held implements and instruments. While the embodiments depicted here are mostly shown as being parts of knives such as a western chef's knife or other kitchen knives, the inventive features and principles apply to other implements and instruments as well, such as gardening tools, surgical tools, sporting goods, guns, mobility controls, and should not be viewed as limited to knives. Further, while all embodiments illustrated herein are designed for a right-handed or ambidextrous user, mirror images of similar embodiments for left-handed users are contemplated by the same inventive principles of the present disclosure.

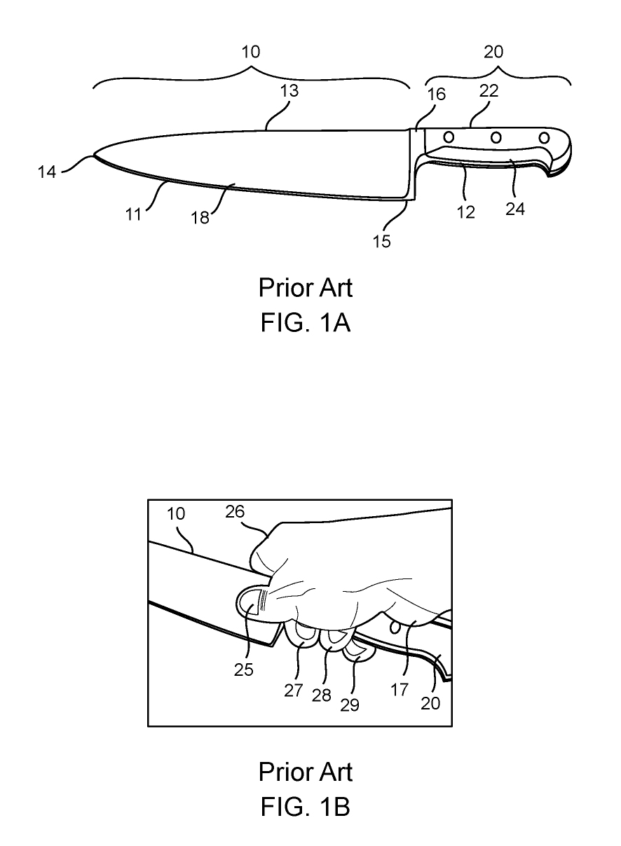

A knife according to the principles of the present invention contains a number of unique features designed to allow the user to more easily and comfortably hold the knife while applying proper culinary techniques. Referring to FIG. 1A, a traditional chef's knife is made of a steel blade 10 that extends into a handle 20 through a tang 12. The blade 10 has a curved and sharpened side 11 for cutting, called the “edge,” and a slightly thicker and opposing side 13 called the “spine”; the part between the edge 11 and spine 13 forms the blade body 18. The blade body 18 increases in width from a pointed front or distal end 14, sometimes called the “point,” to a proximal “return” 15, and typically measures from 6 to 14 inches (about 15 to 36 centimeters) in length. A popular model of the traditional chef's knife has a blade body 18 that is about eight inches (about 20 centimeters) long and about 1.5 inches (about 3.8 cm) at its widest point—around its return 15. Sometimes in between the blade body and the handle is a metallic part 16 called bolster, which is often forged with the blade body 18. The bolster 16 is only slightly thicker than the blade body 18. The handle 20 in the traditional chef's knife has a back 22 that is relatively flat and an opposing belly 24 that is either flat or slightly convex. In the prior art embodiment illustrated in FIG. 1A, metal rivets are used to join the handle 20 to the tang 12.

As shown in FIG. 1B, chefs are taught to place both their thumb 25 and forefinger (also known as the index or trigger finger) 26 on the blade 10, in the so-called “pinch grip,” especially during cutting, dicing and mincing, to have better control of the blade 10. Historically, knife handles or grips run the length of the tang but do not extend into the blade area. This means that the user has to grip the bare metal of the blade body 18 with their forefinger 26 and thumb 25 to hold it properly, and it is this behavior that causes blisters and calluses to form at the base of the forefinger 26. Additionally, the narrowness at the back or proximal area of the handle 20 causes pressure to be placed on the hypothenar muscles 17, which are near the wrist and control the motion of the little finger 29, causing friction and blisters. In an operating kitchen environment, the handle 20 gets slippery very quickly with water, sweat, oil and grease. Because the belly 24 of the traditional handle is smooth (FIG. 1A), and the middle finger 27, the ring finger 28 and the little finger 29 all wrap around it (FIG. 1B), the chef has to constantly make micro motions to adjust the finger positions and/or dry the handle to counter or avoid slippage. In general, the traditional knife handle does not provide natural resting places for the palm or the digits when positioned in the proper pinch grip, and makes its user prone to muscle fatigue and injury.

The present invention addresses these problems by incorporating one ore more of the following features in a handle. Drawings of the present invention depict various views of right-handed embodiments to illustrate principles of the invention; similar embodiments for the left hand are simply mirror images and are contemplated by the present invention as well.

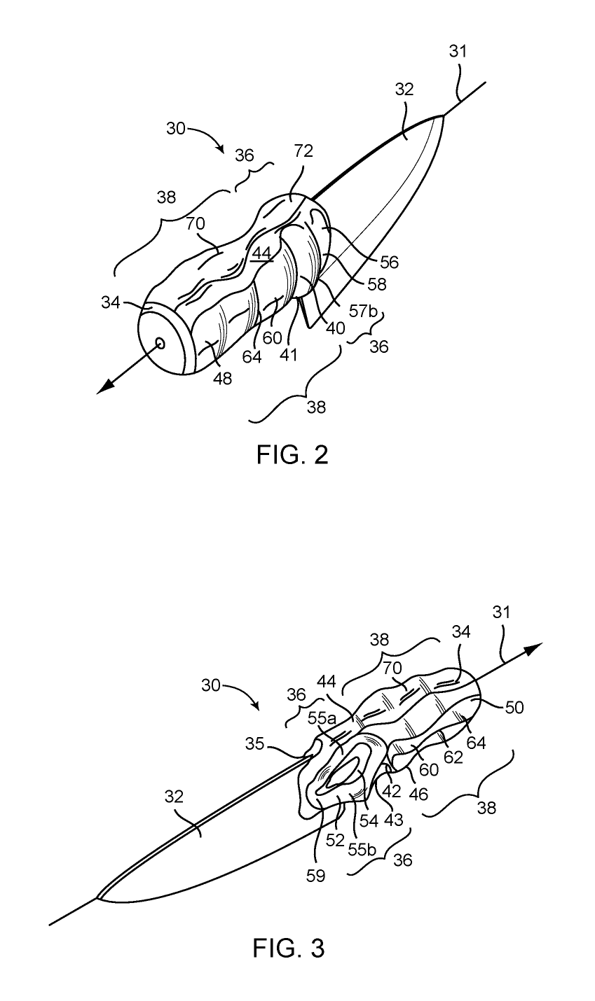

Referring to FIGS. 2-8, a knife 30 according to an embodiment of the present invention is shown to include a cutting blade 32 attached to an ergonomic handle 34 adapted with contoured surfaces to be gripped or held by a user. The configuration and construction of the knife and handle reduce stress and muscle fatigue on the user and improve productivity. Although knife 30 is shown as a general-purpose kitchen knife, it should be appreciated that the knives described herein may be any suitable types of knives, hand-held implements or tools with handle. For example, knife embodiments described herein throughout the disclosure may be a paring knife, a carving knife, a cleaver, a palette knife, a bread knife, a steak knife, a utility knife, a folding knife, a retractable knife, a saw, a gardening tool, etc. It should further be noted that the knife embodiments described in the present invention might be used for cutting, slicing, chopping, mincing, shaving, julienning, filleting, sawing, etc.

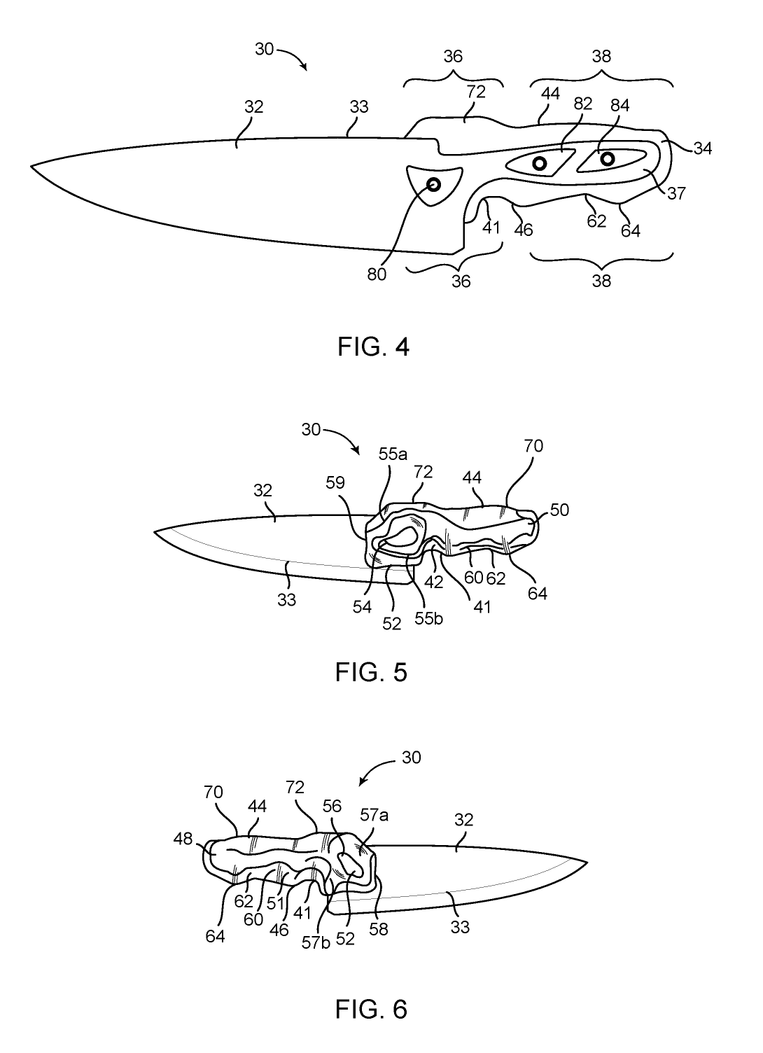

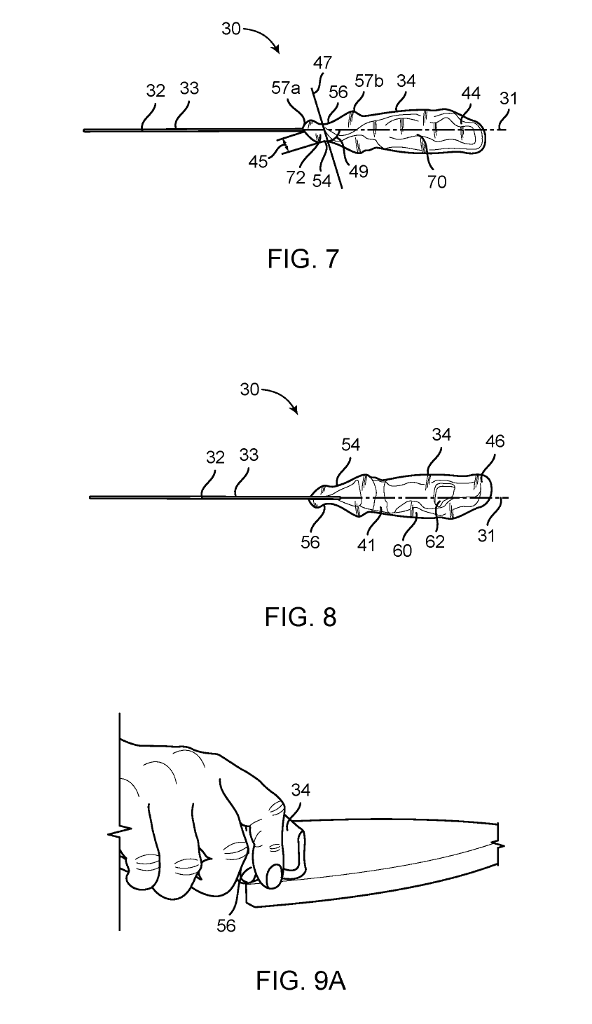

Still referring to FIGS. 2-8, the largely planar blade 32 enters the handle 34 at the handle's distal opening 35, and extends its tang 37 (FIG. 4) inside a longitudinally extending cavity in the handle 34. A longitudinal axis 31 of the handle 34 sits in the plane defined by the cavity intended for the blade 32, or, simply, by the blade 32 once assembled with the handle. In the illustrated embodiment, the handle 34 is between about 12 and 15 cm, or preferably about 13 and 14 cm. A handle of that size can be used to fit blade bodies of multiple lengths, such as the 6-, 8-, and 10-inch version (not counting length of the tang), i.e., blade bodies that are about 152, 203, and 254 mm long. Notice that in a preferred embodiment where the fit between the handle and the user's hand is optimized, the handle 34 is asymmetric about the longitudinal axis 31, as best seen in FIGS. 7 and 8.

The handle 34 can be viewed as consisting of a distal portion 36 and a proximal portion 38, roughly divided by a middle finger recess 41 (FIG. 4) that traverses the handle's right side in the form of a recess 40 for the middle finger's proximal phalanx (FIG. 2), wraps around the belly underneath the handle as a recess 43 for the intermediate phalanx (FIG. 3), and continues onto the handle's left side as a recess 42 for the distal phalanx (FIG. 3). The two handle portions 36 and 38 together form an organic structure with a contoured outer surface that has an upper back 44 opposite an under belly 46 as well as two lateral sides (right side 48 and left side 50) in between the back and the belly. The handle 34 is preferably configured with one or more structural features as follows: special areas that cover part of the proximal portion of the blade, recesses or indentations (often trough-like) respectively designated for a plurality of a human user's fingers, additional reinforcement for the fingers to accommodate common motions, pressure-spreading areas specially designed for different parts of the human hand, as well as other features in the knife. Examples of the inventive features are as follows:

(1) Pinch Grip Pad and Recesses for Thumb and Forefinger

As best seen in FIGS. 5-8, to facilitate a sturdier pinch grip over the blade, the distal handle portion 36 of the knife 30, according to a feature of the invention, substantially extends over the blade body 33 rather than stopping before it, as in prior art embodiments. A handle area over part of the proximal portion of the blade body 33, called the “pinch grip pad” 52, needs to be substantial enough, on one and preferably both sides of the blade body, to accommodate most, and preferably, the entire thumb and forefinger of the user. In preferred embodiments, the pinch grip pad 52 amounts to at least about one eighth (⅛), one seventh ( 1/7), one sixth (⅙), one fifth (⅕), one quarter (¼), or, one third (⅓) of the blade body area. The shape of the pinch grip pad 52 can be any suitable shape, e.g., oval, round, irregular, or, closer to a rectangular or square shape as shown FIGS. 5 and 6. Further, the shape and size of the pinch grip pad 52 can be customizable depending on the dimensions of the user's hand and his preferred grip.

In a feature of the invention, the pinch grip pad 52 is preferably equipped with support structures designated for the thumb and the forefinger, respectively. The support for a finger (including the thumb), as described in this invention, is a raised area or a recess in most cases; however, in some cases, it can be a flat area. For example, in a preferred embodiment, a thumb recess 54 (best viewed in FIG. 5) and a forefinger recess 56 (best viewed in FIG. 6), are provided in the handle 34 to fit and support the thumb and forefinger, respectively, of a typical adult user. The recesses 54 and 56 are indented into the pinch grip pad 52 and defined by walls (55a, 55b) and (57a, 57b), respectively. The walls of the recesses described here and after, including recesses 54 and 56, provide support against forces directed at the knife by the digits and aim to reduce any ensuing slippage—these walls, including the bottom and side walls, may have an additional friction-enhancing coating or a textured surface for that same purpose. The recess walls may be of various widths, heights and thicknesses, and may be reinforced with additional materials such that they resemble protrusions or ridges that rise above surrounding surfaces. In some embodiments, however, the recess walls do not rise above the surrounding surfaces and the recess simply appears as an indentation in an otherwise flat area. The width and depth of the thumb and forefinger recesses 54 and 56 are customizable depending on the size and shape of the user's digits and his preferred grip, but are preferably designed with the walls having obtuse, gradual angles so that they can accommodate a range of user positions within the “pinch grip.”

Referring specifically to FIG. 5, in a preferred embodiment, the thumb recess 54 extends from a front-lower end in the pinch grip pad 52 in an up-and-backward direction to its other end in the handle back 44 (e.g., forming an angle that is about 15, 20, 30, 35, 40, 45, 50, 55, or 60 degrees with the handle back 44, in other words, with the handle longitudinal axis 31). In the particular embodiment illustrated in the figure, the thumb recess 54 resembles a trough defined by two walls 55a and 55b, together forming a rectangular area measuring about 2 inches by about 1.5 inches, i.e., about 51 mm by about 38 mm.

Referring now specifically to FIG. 6, the forefinger recess 56 extends more vertically, i.e., forming an angle much closer to 90 degrees to the handle back 44, in other words, to the handle longitudinal axis 31: e.g., about 65, 70, 75, 80, 85, or 90 degrees. In the particular embodiment illustrated in the figure, the forefinger recess 56 resembles a trough defined by two walls 57a and 57b where the proximal wall 57b is more reinforced, hence higher, compared to the distal wall 57a (see FIG. 7). The walls and the recess 56 together form a roughly quadrilateral area measuring about 1.5 inches by about 1.7 inches, i.e., about 38 mm by about 43 mm. In various embodiments, the two trough angles (or, recess angles), formed respectively by the thumb recess 54 and the forefinger recess 56 with the handle longitudinal axis 31, differ by about 10, 20, 30, 40, 50, 60, 70, or 80 degrees, and in preferred embodiments, by about 20-50 degrees. The difference in the degrees helps the user's hand to maintain a more natural posture of a pinch grip and, therefore, enhances the ergonomics of the instrument.

In an optional feature, to also accommodate a range of positions and to tolerate different users, the forefinger recess 56 deepens towards its lower end 58 as the handle surface material gets thinner and tapers to meet the blade body 33 (better viewed in FIGS. 2 and 6). This allows the user to move the forefinger up and down the forefinger recess 56 and even onto the blade body 33 when the use so dictates. Similarly, the thumb recess 54 can also taper at its lower end 59 as it meets the blade body 33 (better viewed in FIGS. 3 and 5).

While the exact dimensions, locations and orientations of the thumb recess 54 and the forefinger recess 56 depend on the dimensions and positions of the user's thumb and forefinger during a preferred pinch grip, the default configuration in the inventive embodiments have the two recesses “staggered” (best viewed in FIGS. 5-8) in terms of their relative positions along the longitudinal axis 31 where they meet the handle back 44, and in a preferred embodiment, as well as where the two recesses meet the blade body 33. This allows additional handle materials, hence greater thickness, between the thumb and the forefinger during use, and also encourages a more comfortable pinch grip than having the thumb and forefinger directed at each other during the grip.

As illustrated in FIG. 7, in preferred embodiments, the distance 45 between the trough bottoms of the thumb recess 54 and of the forefinger recess 56, i.e., where they are closest to each other, is about 8.0 to about 15.0 mm, and more preferably about 10.0 to about 12.0 mm. Also in preferred embodiments, a line 47 connecting the trough bottoms of the thumb recess 54 and the forefinger recess 56 forms an angle 49 with handle longitudinal axis 31 that is in a ranger where 30 degree is the low end and 90 degree the high end, exclusive of both endpoints. Preferably, the angle 49, which means the two recesses are staggered, is between a ranger where 40 degree is the low end and 89 degree the high end, inclusive of both endpoints.

(2) Thumb Stop

According to another feature of the invention, best viewed in FIGS. 3 and 5, to provide additional support for the thumb during cutting, which is largely a downward movement, the lower wall 55b of the thumb recess 54 is optionally reinforced or otherwise made thicker, higher, and bulkier into a protruding ridge as a thumb stop. While the shape and position of this feature is customizable depending on the dimensions of the user's hand and his preferred grip on the pinch grip pad 52, in a default embodiment, the lower ridge 55b extends perpendicularly away from the blade/tang for about 10 to about 25 mm at its farthest point, and more preferably, for about 15 to about 22 mm at its farthest point, resembling a horizontal platform. Further, this horizontal platform extends more or less horizontally, i.e., in roughly the same planar direction as the handle back 44, for the entire length of the pinch grip pad 52.

(3) Forefinger Stop

Still referring to FIGS. 2-8, according to a further feature of the invention, the proximal wall 57b of the forefinger recess 56 is optionally reinforced or otherwise made thicker, higher, and bulkier into a protruding ridge as a forefinger stop to provide additional support for the forefinger during use. While the shape and position of this feature is customizable depending on the dimensions of the user's hand and his preferred grip on the pinch grip pad 52, in a default embodiment, the proximal forefinger ridge 57b, extends perpendicularly away from the blade/tang for about 10 to about 22 mm, and more preferably about 14 to about 18 mm, at its farthest point, resembling a vertical backstop for the forefinger.

(4) Middle Finger Support and Stop

According to a feature of the present invention, an optional middle finger support is provided, e.g., in the form of a raised area or a recess 41 that travers the vertical depth of the handle's right side 48 (FIG. 2), the girth/width of the handle belly 46 (FIG. 4) and part of the vertical height of the handle's left side 50 (FIG. 3). While the shape and position of this feature is customizable depending on the dimensions of the user's hand and his preferred grip, in a default embodiment, the recess 40 for the proximal phalanx of the middle finger is situated immediately proximal to the back ridge 57b for the forefinger and extends vertically across the handle right side 48 from the handle back 44 to the handle belly 46 (FIG. 6); the middle finger recess 41 continues across the handle belly 46 for positioning the intermediate phalanx of the middle finger (FIG. 8), and emerges on the handle left side 50 just proximal to the thumb stop/ridge 55b as a shorter recess 42 for positioning the distal phalanx of the middle finger (FIG. 5).

This indentation/recess allows for better control of the blade using the middle finger. Specifically, The middle finger recess 41 is defined by a distal wall, which is the proximal side of the thumb stop 55b, and which offers support for a pushing motion during use (see FIG. 5). And recess 41's proximal wall/ridge 51 serves as a middle finger stop providing additional support for a pulling motion towards the butt of the knife on the opposing side (see FIG. 6).

(5) Ring Finger Support

According to a feature of the present invention, support is provided, e.g., in the form of a raised area an optional recess 60 for the ring finger proximal to the middle finger support or recess 41 (better viewed in FIGS. 2, 3, 5 and 6). While the shape and position of this feature is customizable depending on the dimensions of the user's hand and his preferred grip, in a default embodiment, the ring finger recess 60, similar to the middle finger recess 41, travers the vertical depth of the handle right side 48, the girth/width of the handle belly 46 and part of the vertical height of the handle left side 50. The indentation for this feature can be less pronounced than some of the other recesses. The ring finger recess 60, along with its defining ridges, lends support to the ring finger during the operation of the knife as well as a designated space for the ring finger to stay relatively immobile during the entire grip.

(6) Little Finger Support and Stop

According to a feature of the present invention, an optional recess 62 for the little finger (or, pinkie) is provided proximal to the ring finger recess 60. While the shape and position of this feature is customizable depending on the dimensions of the user's hand and his preferred grip, in a default embodiment, the little finger recess 62, similar to the middle finger recess 41, travers the vertical depth of the handle right side 48, the girth/width of the handle belly 46 and part of the vertical height of the handle left side 50 (better viewed in FIGS. 4-6). In some embodiments, the middle finger recess 60 and the little finger recess 62 are combined into a larger recess to accommodate both fingers side by side (see FIGS. 2 and 4).

The indentation for this feature can be less pronounced than some of the other recesses. However, in a preferred embodiment of the present invention, a pinkie stop 64 is provided to support the back of the pinkie during cutting motions. Additional support is preferred here because the pinkie is the most proximal finger during a regular grip, and hence among the last chances to stop the hand from slipping off the handle. This additional support here is even more important when an embodiment elects to have little or no recess for the ring finger or the pinkie itself. While the shape and position of this feature is customizable depending on the dimensions of the user's hand and his preferred grip, in a default embodiment, the pinkie support 64 takes the form of a projection or protrusion away from the handle's belly 46.

(7) Pressure Spreading Areas

In one feature, the knife of the present invention includes one or more specially designed areas with geometries intended to reduce the chaffing and pain associated with holding a traditional knife in the pinch grip position. The first is a broad area 70 on the handle back 44 situated in the proximal handle portion 38 toward the butt of the knife, proximate to the little finger recess 62 and pinkie stop 64 (better viewed in FIGS. 2, 3 and 7). In a preferred embodiment, this “proximal pressure spreading area” 70 is widened, relatively flat but can include gradual contours and undulations. The proximal pressure spreading area 70 is designed to spread forces that the heel of the hand, specifically the hypothenar muscles, encounters during a grip. Handles without this feature tend to quickly lead to blisters and hand fatigue. While the shape and position of this feature is customizable depending on the dimensions of the user's hand and his preferred grip, in a default embodiment, the proximal pressure spreading area 70 is wider than any part of the handle distal portion 36 and has an average width of at least about 25, 30, 40, or 45 mm.

The second such feature that a knife of the present invention may adopt is a protrusion in the handle distal portion 36 that forms a ridge 72 on the knife back 44, proximate to the forefinger recess 56 (better viewed in FIGS. 2, 6 and 7). This spreads out the pressure on the proximal phalanx of the forefinger and on the metacarpal below it, hence reducing friction, fatigue and calluses. While professional chefs tend to build up calluses in these areas from years of abuse and have a higher tolerance, addition of the “distal pressure spreading area” 72 benefits users of all levels of experience. The shape and position of this feature is customizable depending on the dimensions of the user's hand and his preferred grip. In a default embodiment, the distal pressure spreading area 72 resembles a gently sloped hump or raised portion where walls defining the forefinger recess 56 and the middle finger recess 40 on one side, and the wall defining the thumb recess 54 on the other, rise as a plateau over the handle proximal portion 38 for at least 1, 2, 3, 4, 5, 6, 7, 8, 9, or 10 mm. In one embodiment, the distal pressure spreading area 72 is asymmetrically about the handle longitudinal axis 31 (see FIG. 7), and is raised over the handle proximal portion 38 for about 5 mm.

(8) Designated Support for Each Finger

While the support/recess and stop described herein for each individual finger are optional, in a preferred embodiment, the handle 34 of the present invention includes a support or recess designated for each of the five fingers of a human hand. Specifically, and referring to FIGS. 2-8, these structures are: the thumb recess 54 (optionally with the reinforced thumb stop 55b), the forefinger recess 56 (optionally with the reinforced forefinger stop 57b), the middle finger recess 41 (optionally with the reinforced middle finger stop 51), the ring finger recess 60, and the little finger recess 62 (optionally with the reinforced pinkie stop 64). Additional, the preferred embodiment may also include the proximal and distal pressure spreading areas 70 and 72, respectively. Again, while the finger support features are illustrated as recesses, they can also be raised areas.

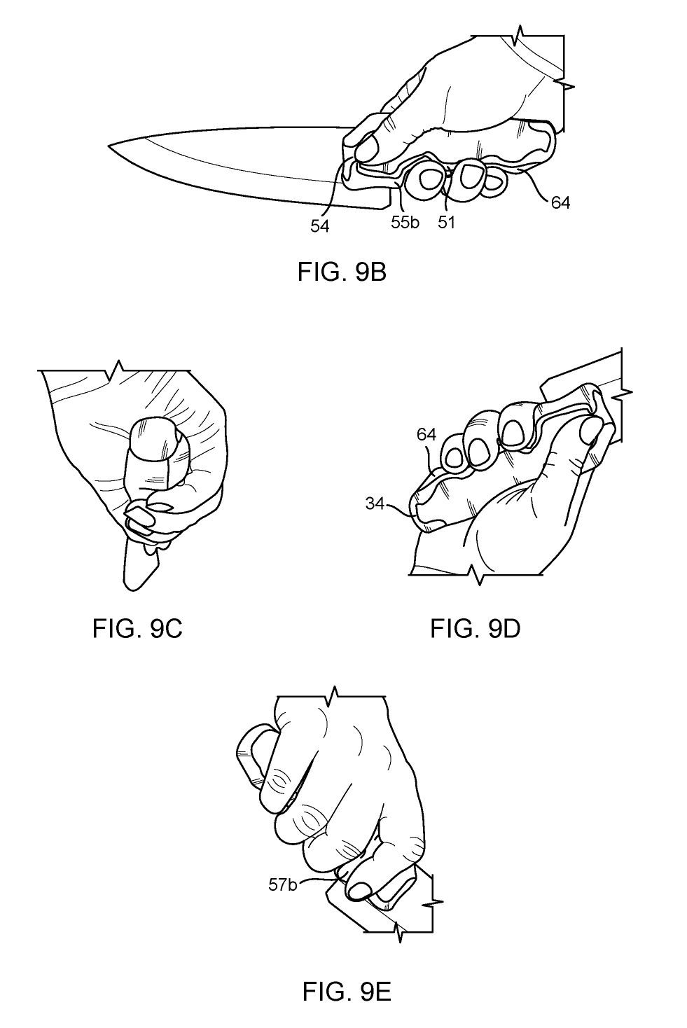

This ergonomically optimized handle embodiment 34 provides a glove-like fit for all five digits of the user, as shown in FIGS. 9A-9E. With designated recesses for each finger, the user's hand can comfortably hold a steady grip over the blade, control its movement with precision, and exert force as needed, all the while without slippage or fatigue.

(9) Blade Attachment

Referring now to FIG. 4, in order to attach the handle 34 to the blade 32, there may be one or more openings, such as openings 82 and 84, in the blade's tang 37 through which hardware such as rivets can affix one side of the handle to the other, or both sides of the handle can meet (in the case of a poured or injection molded handle production). According to a feature of the present invention, an additional, novel opening 80 is located in the proximal portion of the blade body 33 where the pinch grip pad 52 will be. The blade body opening 80 serves the purpose of securing the pinch grip pad 52 of the handle to the blade body 33.

(10) Bi-Configuration Handle

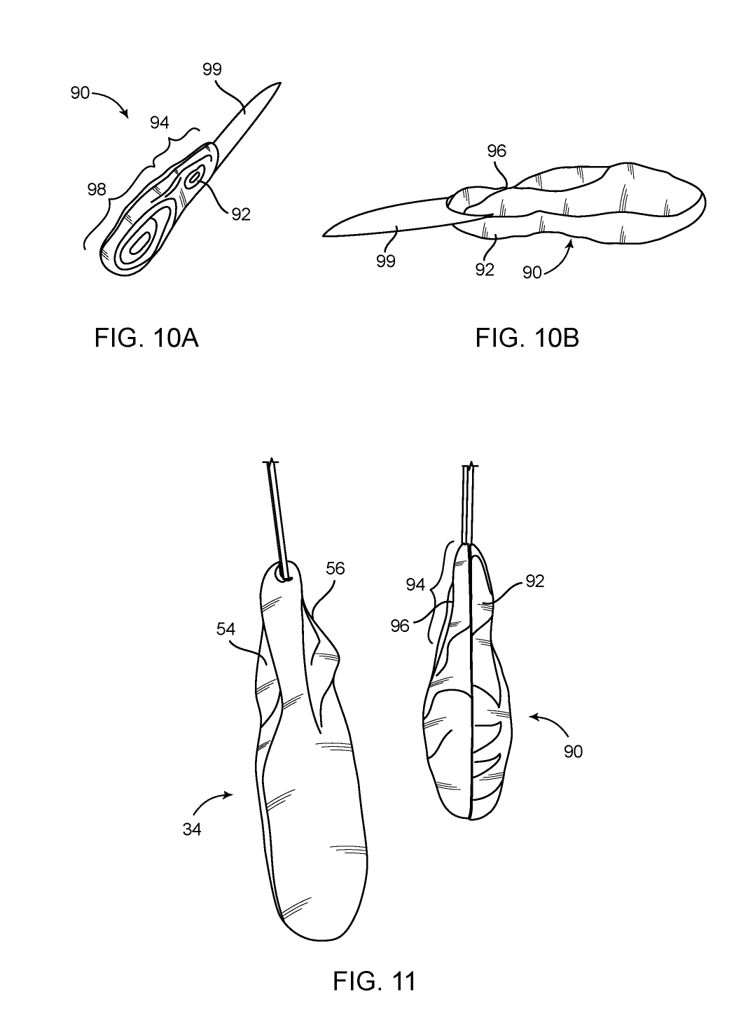

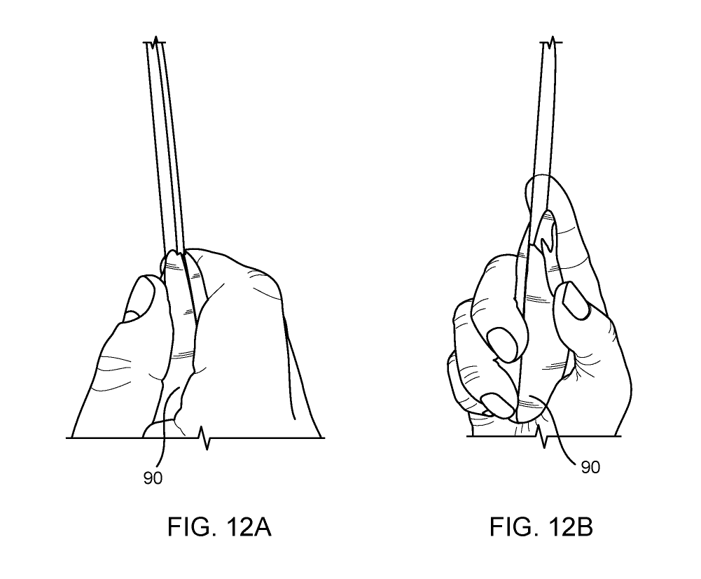

In another aspect of the invention, an embodiment of the present invention provides structural features that facilitate more than one preferred grips by the user. In the example illustrated in FIGS. 10A, 10B, 11, 12A and 12B, a hand-held instrument, e.g., a knife, can be comfortably and ergonomically gripped by an adult hand in at least two different grips, hence, a bi-configuration handle 90. For the illustrated embodiment, one grip is the pinch grip where the thumb and the forefinger are positioned at either sides of the distal portion of the handle 90 (FIG. 12A). The alternative grip allows the user to keep the thumb on the same side of the handle 90 but move his forefinger over the back of handle 90 (FIG. 12B).

In order to achieve the above goal, the handle 90 provides designated structures or features for the thumb and the forefinger in the form of a thumb support and a forefinger support. Referring now to FIG. 11, compared to the handle embodiment 34 illustrated in FIGS. 2-8, the present handle embodiment 90 differs as follows: instead of having both a thumb recess 54 and a forefinger recess 56 in the handle distal portion, i.e., in the pinch grip pad, one of the recesses is now replaced with a reinforced or raised area 92 in the form of a protrusion, a bump, or a projection. In the particular embodiment depicted, the raised area 92 serves as a forefinger rest while a thumb recess 96 is retained. But the two could flip in an alternate embodiment with a raised thumb rest and a forefinger recess as long as there is sufficient width in the distal portion 94 of the handle 90 to enable the forefinger to rest comfortable on the handle back during the alternative grip depicted in FIG. 12B while still allowing the user's thumb and forefinger to utilize built-in structures (i.e., a recess and a rest) for a pinch grip. In various embodiments of the invention, the portion of the handle back where the thumb support and the forefinger support are disposed, i.e., the distal portion of the handle back, has an average width of no less than 5, 6, 7, 8, 9, 10, 11, or 12 mm. In a preferred embodiment, the average width of the handle distal portion is no less than 10 mm.

Referring to FIGS. 10A and 10B, the handle 90 includes a distal portion 94 which includes the thumb recess 96 and the forefinger rest 92, and a bulbous proximal portion 98. The handle 90, in various embodiments, is about 10, 11, 12 or 13 cm. This length advantageously allows an adult hand to hold the butt of the handle against the palm for certain maneuvers (see FIG. 12B). A blade 99 is fitted into the handle 90, with part of the handle distal portion 94 partially covering the proximal portion of the blade 99, in other words, as a pinch grip pad. The blade 99 can be, for example, that of a paring knife, utility knife, or bread knife.

(11) J-Shaped Handle

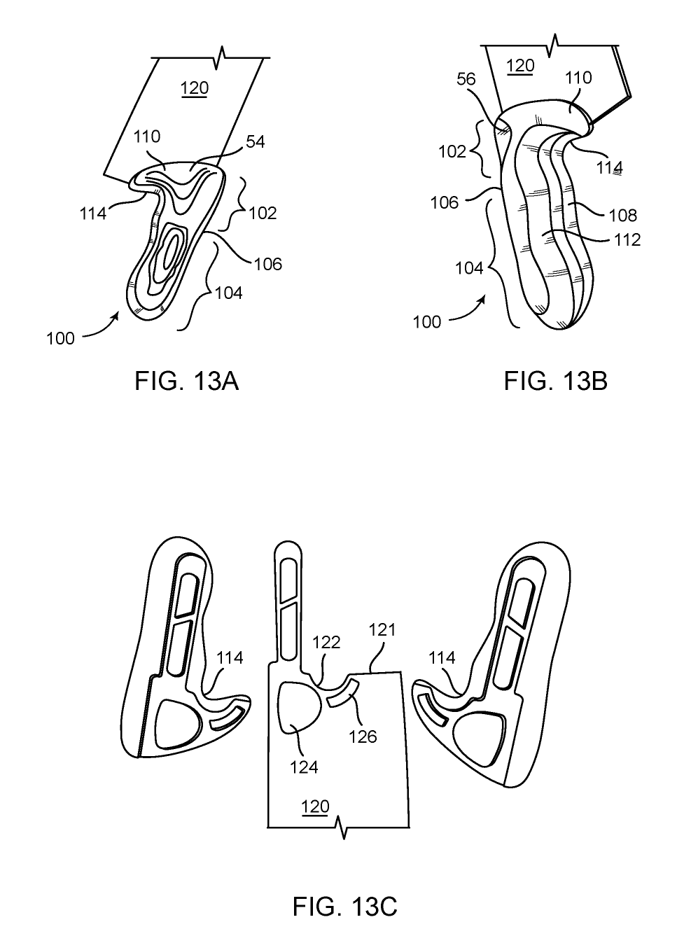

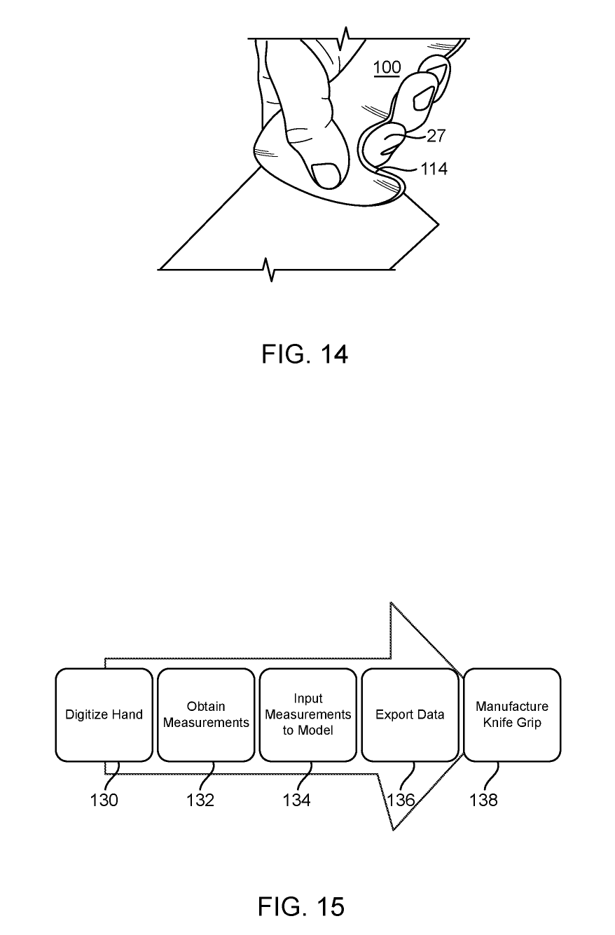

Referring to FIGS. 13A-13C, in yet another aspect of the invention, an embodiment of the present invention provides a handle 100 that resembles a “J.” Referring specifically to FIGS. 13A and 13B, the handle 100 includes a distal portion 102 and a proximal portion 104; the handle 100 further includes a back 106 and an opposing belly 108. Similar to the handle embodiment 34 illustrated in FIGS. 2-8, the present handle embodiment 100 also provides a thumb support and a forefinger support: e.g., a similar thumb recess 54 and a forefinger recess 56, both disposed in a pinch grip pad 110 that covers part of the proximal portion of the blade 120. The pinch grip pad 110 extends away from the handle body 112, forming a J-shaped object. The inside turn of the “J”—part of the handle belly 108—preferably defines a cutout, recess, or depression 114 that is shaped and dimensioned to accommodate a user's finger, e.g., the girth of a middle finger. For example, the depression 114 may comprise an arc with a radius of about 5, 7, 10 mm, or a less pronounced concave surface. The depression 114 is defined by a belly surface against which a user can rest his middle finger 27 during use (FIG. 14), and that part of the belly surface is preferably between about 10 to about 40 mm, more preferably about 15 to about 30 mm in width as measured perpendicularly to the handle longitudinal axis. Accordingly, the user's middle finger would not be bumping against a thin blade during use especially when the impact on the middle finger is substantial, e.g., during a chopping motion.

Referring now to FIG. 13C, in a preferred embodiment, the proximal edge 121 of the blade 120 includes a cutout 122 that roughly corresponds to where the handle depression 114 is going to be such that, after assembly, the blade's proximal edge 121 does not stick out of the handle depression 114. In order to secure the J-shaped handle 100 to the blade 120, there may be one ore more openings 124 and 126 in the proximal portion of the blade 120, in areas intended to be covered by the pinch grip pad 110. While the J-shaped handle 100 can be used to fit many different instruments including knives, it is particularly suitable to fit a cleaver blade.

(12) Blade Coating

In various embodiments of the invention, the blade body or its cutting edge may be coated in a coating of a ceramic or other hardened material. The coating may serve the purpose of extending the life of the edge, or protecting the underlying steel or for decoration.

(13) Customization

Referring now to FIG. 15, a method of making customized embodiments according to another aspect of the present invention is illustrated.

Scan/digitize hand: In step 130, using a conventional 2D system such as a flatbed scanner or copy machine, an image of the user's hand is digitized. A photograph may also be used if taken from a perpendicular perspective (or software is used to mitigate distortion caused by perspective issues if the shot is taken from an angle). The scan may also be obtained using a 3D scanning system such as with a laser to create point cloud data, a sonar style device or by stitching together multiple photographs.

Obtain measurements: In step 132, biometric measurements are extracted from the scan, including but not limited to the overall lengths and widths of digits (e.g., all five of them), lengths and widths of the proximal, middle and distal phalanxs (e.g., of each digit), spacing between fingers (e.g., as measured from the center points at their respective bases), length of palm, and width of palm. Such extraction can be done manually by measuring and comparing to a known reference object in the frame (such as a US quarter) or in an automated fashion via a specialized program.

Input values into model: In step 134, once extracted, the values are used to modify the digital model of the handle. This can be executed by an automated program which directly inserts the biometric data from the scan or can be accomplished by manually modifying individual values in a digital model of the handle or by modifying values of a digital hand model which is mated to the handle. Various computer programs are commercially available for the purpose of practicing this step, e.g., the SolidWorks® program.

Export data—In step 136, the new custom digital model is prepared and exported in a format compatible for production such as an .STL file. This file can then be converted to a machine code such a g-code via a CAM program or a plugin.

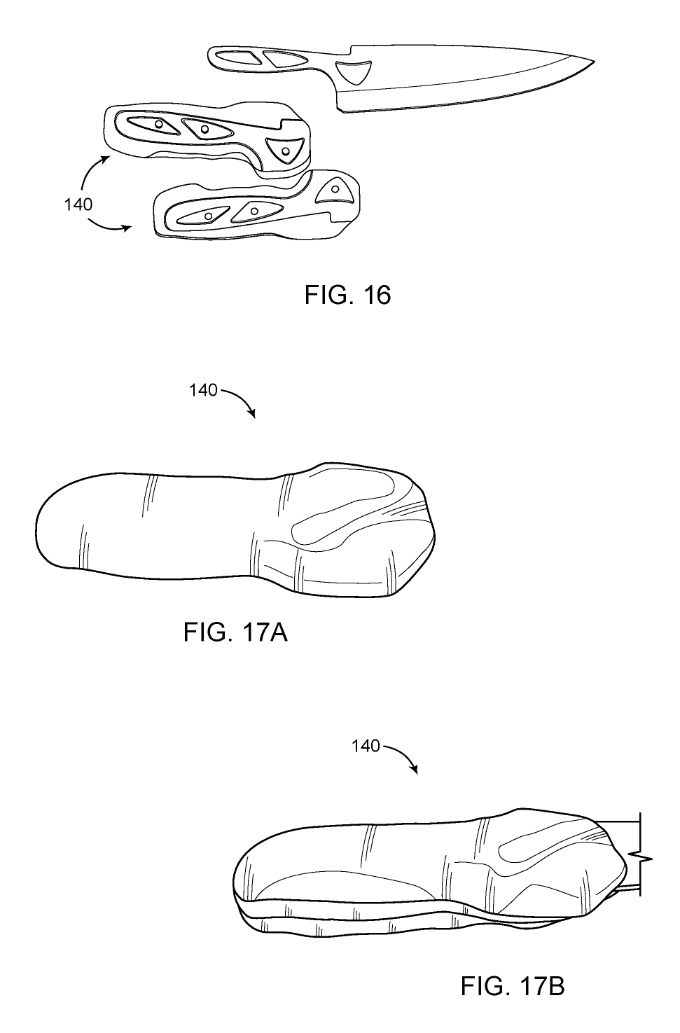

Production—In step 138, the handle is fabricated though any suitable technologies, e.g., dip molding, injection molding, foam extrusion and sleeve molding, additive technology such as 3D printing or subtractive technology such as CNC milling. Suitable materials such as polymers, plastics, silicones, wood, stone and metals such as all kinds of thermoplastic elastomers (TPEs), can be used to make various handle embodiments of the invention disclosed herein. In a preferred embodiment, the handle of the invention is made of platinum-cured silicone, which has a higher melting point compared to some of the other candidate materials. Different parts may be made in separate processes and assembled in a final step (FIG. 16).

An embodiment customized with right-handed user's hand scan image according to steps 130-138 is shown in FIGS. 17A and 17B, where a polymeric handle 140 is produced using 3D printing technology.

(11) Knife Roll

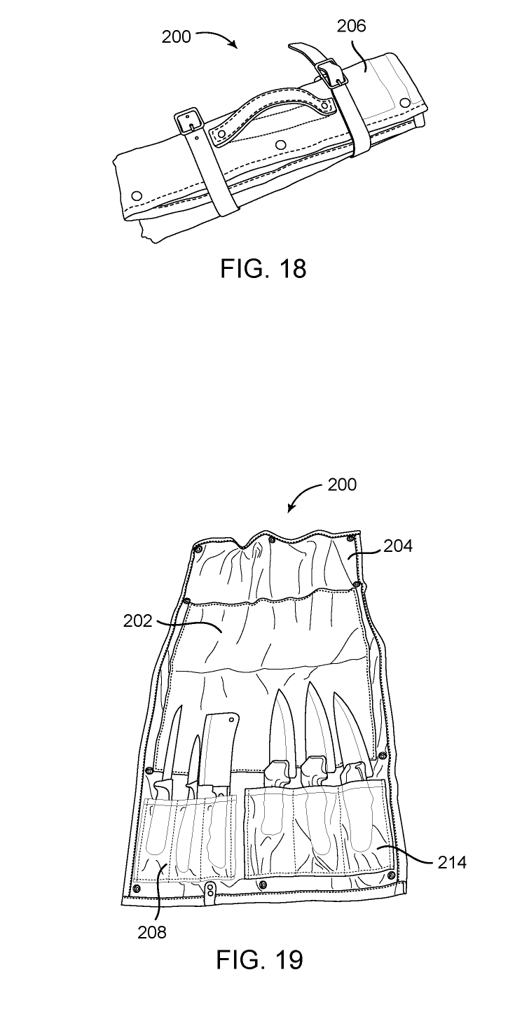

Knife rolls are carrying cases specifically designed to protect and transport knives, other handheld instruments and accessories. The present invention, according to one aspect, provides a novel knife roll or otherwise a container for storing and transporting sharp implements. Referring now to FIGS. 18 and 19, a bag container, specifically, a knife roll 200 is shown to have stab-resistant, cut-resistant materials, such as woven or knit aramids, polyesters, or other such materials 202, as part or the entirety of the knife roll's inside 204, and/or its outside 206 in order to make the knife roll cut- or stab-resistant. Such fabrics not only better protect the knives in the knife roll but also keep the roll from fraying or being pierced, further extending the longevity of the knife roll. In an embodiment, the stab-proof material 202 is Kevlar®, an aramid fiber manufactured by DuPont®. In a preferred embodiment, the bag container is overall flexible enough to be rolled up.

As shown in FIG. 19, the knife roll 200 includes multiple pockets or compartments 208 for housing handles of the knives and accessories at the bottom of an inside panel 204. A panel made of the stab-resistant material 202 is disposed proximate to the compartments 208 such that the panel will wrap around the blades or other sharp portions of implements housed in the compartments when the knife roll is properly closed. In one feature, the knife roll 200 can be folded in half along a center line, with the stab-resistant material 202 on both sides of the blades contained in the roll. Once folded in half, the knife roll 200 can be rolled together and tied up as shown in FIG. 18.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

1. A handle dimensioned to be held by a single human hand, said handle comprising a distal portion and a proximal portion, said portions together forming an upper back and an opposing lower belly as well as two lateral sides;
wherein said distal handle portion further comprises a thumb support and a forefinger support flanking a longitudinal axis of said handle, and wherein said thumb support and said forefinger support are staggered to facilitate a pinch grip by the human hand where both a thumb and a forefinger of the hand fictionally engage said thumb support and said forefinger support from respective lateral sides in order to grip said distal handle portion; and
wherein a line between the closest points between said thumb support and said forefinger support defining an angle is between 30 and 90 degrees, exclusive of both endpoints, to said longitudinal handle axis.

2. The handle of claim 1 wherein the closest distance between said thumb support and said forefinger support is between about 8.0 to about 15.0 mm.

3. The handle of claim 1, further defining a cavity configured to fit a tang of a hand-held implement, said cavity defining said longitudinal handle axis.

4. The handle of claim 1, wherein each of said thumb support and forefinger support comprises two walls defining a recess.

5. The handle of claim 1, wherein a lower ridge defining said thumb support comprises a reinforced thumb stop that extends perpendicularly away from said longitudinal handle axis for about 10 to about 25 mm at its farthest point.

6. The handle of claim 1, wherein said distal portion further comprises a substantial, raised portion relative to said handle proximal portion for at least 2 mm, said raised portion configured for spreading pressure on the proximal phalanx of the forefinger and on the metacarpal.

7. The handle of claim 1, wherein said handle further comprises five recesses, each disposed and configured to respectively accommodate each of the five digits of the user's hand and two of which are said thumb support and said forefinger support, respectively.

8. The handle of claim 1 further comprising a middle finger recess disposed and configured to accommodate a user's middle finger.

9. The handle of claim 1 further comprising a projection disposed in the proximal portion and configured to provide additional support for a user's little finger.

10. The handle of claim 1, wherein said upper back in said proximal portion is widened for spreading pressure on the heel of the hand and has a width larger than any part of said distal portion.

11. The handle of claim 10, wherein the widest part of said proximal portion is no less than 25 mm.

12-20. (canceled)

21. A knife comprising a blade connected to a handle, said blade comprising body having a proximal side, at least part of which is covered by said handle, said handle comprising a proximal portion and a distal portion covering part of said blade body, said handle proximal portion and said handle distal portion joining to form a “J” having a back and an opposing belly as well as two lateral sides,
and wherein said handle belly comprises a depression dimensioned and disposed over said blade proximal side to accommodate a user finger.

22. The knife of claim 21, wherein said blade proximal side comprises a cutout dimensioned and disposed to correspond to said depression in the handle belly.

23. The knife of claim 21, wherein blade comprises a cleaver blade having four sides.

24. The knife of claim 21, wherein blade comprises a blade having a pointed distal end.

25. The knife of claim 21, wherein said depression is defined by a handle belly surface that is between about 10 to about 40 mm in width.

26. (canceled)

27. A handle dimensioned to be held by a single human hand, said handle comprising a distal portion and a proximal portion, said portions together forming an upper back and an opposing lower belly as well as two lateral sides;
wherein said distal handle portion further comprises a thumb support and a forefinger support flanking a longitudinal axis of said handle, and wherein between said thumb support and said forefinger support, one comprises a raised rest and the other a recess; and
wherein the average width of said handle distal portion is no less than 5 mm.
